(19) United States
(12) Patent Application Publication
(10) Pub. No.: US 2020/0394727 A1
(43) Pub. Date: Dec. 17, 2020

(54) FOOD ORDERING SYSTEM BASED ON PREDEFINED VARIABLES

(71) Applicants: Rama Joshua Shadrokh, Great Neck, NY (US); Cristina Garcia Jaime, Ubrique (ES)

(72) Inventors: Rama Joshua Shadrokh, Great Neck, NY (US); Cristina Garcia Jaime, Ubrique (ES)

(21) Appl. No.: 16/436,958

(22) Filed: Jun. 11, 2019

(51) Int. Cl. G06Q 50/12; G06Q 30/06; G06N 5/02

(52) U.S. Cl. CPC G06Q 50/12; G06N 5/02; G06Q 30/0631

(57) ABSTRACT

The present invention relates to a system of recommending food items based on a set of predefined variables. The system of recommending food items includes databases of ingredients, recipes, items, restaurants and users. The system may recommend the menu items based on the variables related to location, time, nutrition habits, prize, size and popularity, as well as further filtering the restaurants and items at the beginning of the process.

### CROSS REFERENCE TO RELATED APPLICATIONS

This patent application is a Continuation-In-Part of U.S. patent application Ser. No. 15/672,340 filed on Aug. 9, 2017.

### BACKGROUND OF INVENTION

### Field of Invention

This invention relates to a system for recommending food items and more specifically to an innovative system that assess the customer behavior towards ordering food items and learning from the customer experience in order to predict food orders during food ordering process with the help of Artificial Intelligence protocols.

### Description of Prior Art

Any discussion of documents, acts, materials, devices articles or the like which has been included in this specification is solely for the purpose of providing a context for the present invention. It is not to be taken as an admission that any or all these matters form a part of the prior art or were common general knowledge in the field relevant to represent invention as it existed in the United States of America or elsewhere before the priority date of this application.

Online food ordering and ecommerce industry is booming day by day. While there are several food businesses focusing on analyzing the right keywords in the purchase history of a consumer but none of these applications replicates real life logic used during food decision making process. The present invention aims at targeting the emotional and analytical intelligence of the consumer by replicating the real life logic while ordering food online. Additionally, the present invention aims at targeting the emotional and analytical intelligence of any consumer by analysing the food choices made at different instants of time. Few existing arts in this category include U.S. Patent Application No. US20130339163A1 to Dumontet et al. which discloses a system and methods for predicting food items whose names and/or descriptions contain same or similar words as the food items that the consumer's profile indicates are preferred by the consumer.

U.S. Application No. US20160012513A1 to Martinez et al. talks about a system to recommend food items by determining a probabilistic relationship between either the restaurant ratings or the menu item ratings of at least two users, further filtering based on the data related to the dietary needs and the cuisine type ratings associated with the requesting user, to generate a recommendation related to a restaurant or to a menu item for the requesting user. However, it does not targets the emotional and analytical intelligence of any consumer by analysing the food choices made at different instants of time, neither the disclosed system use more variables that are involved in the decision making process, majority of them are provided directly by the customer unlike the present invention that intuitively through its Artificial Intelligence based system suggests food choices eliminating the need of customers giving direct cues or filling up pop up questionnaires regarding the food they would like to order. The present invention is best explained as a system with analytical and intuitive abilities.

U.S. Pat. No. 9,898,788B1 to Calargun et al. talks about creating a predictive model from the past information and analyzing it to create predictive model that may be configured to automatically order a meal for the customer from a determined restaurant so that the meal arrives at or before the predicted time of day. However, it does not suggest or gives in-depth recommendations of food items based on various other ordering habits of the customer at that mealtime. The more will be discussed in the detailed description section below.

Further another U.S. Patent Application No. US20130151357A1 to Havas et al. talks about a system of enabling group food orders. The method for enabling group food order includes: receiving a food order from a order coordinator, the food order specifying a payment source and a group of participants; prompting each participant to select an alternative food item from a menu of available food items. However, it does not predict orders based on the customer's behavior and/or any real life logics used during food-decision making process.

Yet another U.S. Patent Application No. US20140127651 to Brazell talks about a system having artificial intelligence that searches available information and makes recommendations to the user based on initial input, the user's response to previous recommendations regarding meals, and/or other information regarding the user thereby continually learning more about the user to improve future recommendations regarding meals that the user will enjoy and also meals that meet a user's nutritional requirements or dietary goals.

Another U.S. Patent Application No. US20110166881A1 to Brazzo et al. talks about a method and system of generating food recommendations for a patient based on patient's drug profile describing current medications for a patient. The patient drug profile is analyzed to establish an individual's medical condition(s), or disease state profile, from National Drug Code numbers, for example, in the patient drug profile. A nutritional database is provided. The nutritional database includes foods that are beneficial and/or harmful to various disease states. Food recommendations based on the individual's medical condition(s), or disease state profile, are provided from the nutritional database. The food recommendations can include both foods to avoid and foods to consume.

The prior art is limited with applications and systems merely making recommendations according to fewer parameters like user and restaurant location, types of cuisine and sometimes types of food items. However, none of the cited prior arts disclose a system as intuitive and accurate as the present invention that adapts exactly to the customer behavior during online food ordering process, aided by complex yet space and time efficient food recommendation and artificial intelligence algorithms that directly impacts on the amount of resources required for any given computing function. Hence, lesser resources indicate more efficient computing system.

### SUMMARY OF INVENTION

It is an object of the present invention to overcome, or substantially ameliorate, or one more of the disadvantages of the prior art, or to provide useful alternative.

According to an aspect of the invention, the system utilizes artificial intelligence algorithms to replicate real-life logic used during food decision making process to generate recommendations of the food items while ordering food online.

According to yet another aspect of present invention, the system comprises five databases: ingredients, recipes, food items, restaurants and users databases respectively. These databases are interrelated and gather information from each other to generate their own information or data. The system compares information from said databases (i.e. ingredient, recipe, food items and restaurants databases) to information provided by the user database.

According to yet another object of present invention, the system generates information about the user behavior without the actual need of asking user centric questions. The system works by intuitively studying the customer behavior while ordering food online and auto suggesting various food recommendations.

According to yet another aspect of present invention, the system compares information from said databases (i.e. ingredient, recipe, food items and restaurants databases) to the information provided by the user database with the help of 16 variables including restaurant carrier, restaurant proximity, time of the order or restaurant hours, customer's mealtime, category family, already ordered items, types of cuisine, special dietary needs, macronutrients, food groups, allergens, size of the meal, price of the meal, food item popularity and restaurant popularity and taste.

According to yet another aspect of present invention, the system schedules the meal of the user based on the type of food items the customer ordered over a range of times in a week. The user centric intuitive algorithm of the present invention employs artificial intelligence to schedule customer's next meal.

According to yet another aspect of present invention, the system runs artificial intelligence-based algorithms which are processor intensive and manipulates a lot of data in the computing system's RAM memory. When such processor intensive tasks are executed by said artificial intelligence-based algorithms, it typically uses much of the processors capabilities in order to complete tasks. Hence, the present invention operates at the level of architecture of the computing system.

The features and advantages of the present invention will become further apparent from the following detailed description of preferred embodiments provided by way of example only, together with accompanying drawings.

### BRIEF DESCRIPTION OF DRAWINGS

FIG. 1 illustrates screenshot of ingredient database.

FIG. 2 illustrates screenshot of Restaurant database.

FIG. 3A illustrates screenshot of items database and FIG. 3B illustrates screenshot of recipe database.

FIG. 4A and FIG. 4B illustrates types of cuisine and social groups distribution for mealtimes respectively.

FIG. 5 illustrates how system extracts data to compare mealtime.

FIG. 6 illustrates how the system extracts data to compare cuisine.

FIG. 7 illustrates how the system extracts data to compare food groups.

FIG. 8 illustrates how the system extracts data to compare taste.

FIG. 9 illustrates how system extracts data to compare macronutrient level.

FIG. 10 illustrates how the system extracts data to compare prices.

FIG. 11 illustrates various recommendations of food items.

FIG. 12 illustrates screenshot of the graphical user interface of the present invention.

FIG. 13 illustrates yet another screenshot of the graphical user interface of the present invention.

FIG. 14 illustrates another screenshot of the preferred embodiment.

FIG. 15 illustrates yet another screenshot of preferred embodiment.

FIG. 16 illustrates yet another screenshot of preferred embodiment.

### DETAILED DESCRIPTION OF THE PREFERRED EMBODIMENTS

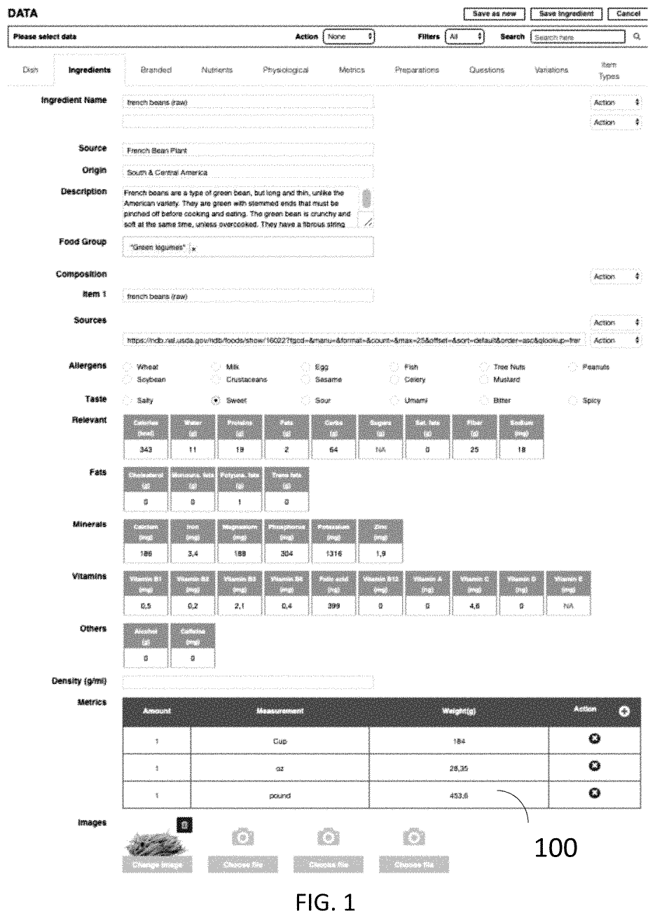

FIG. 1 illustrates a screenshot 100 for ingredient database. There are five databases which are the foundations of the present invention. These databases are related and extract information from each other. Ingredients database is the most basic database needing manual input and is divided in two areas: branded products and regular ingredients. Both of them consist of a list of ingredients with detailed information about several aspects. The information contained for each ingredient includes: Ingredient name, source from where the ingredient is obtained, description which explains the usual colours, texture, flavours and uses among other important characteristics of the ingredients.

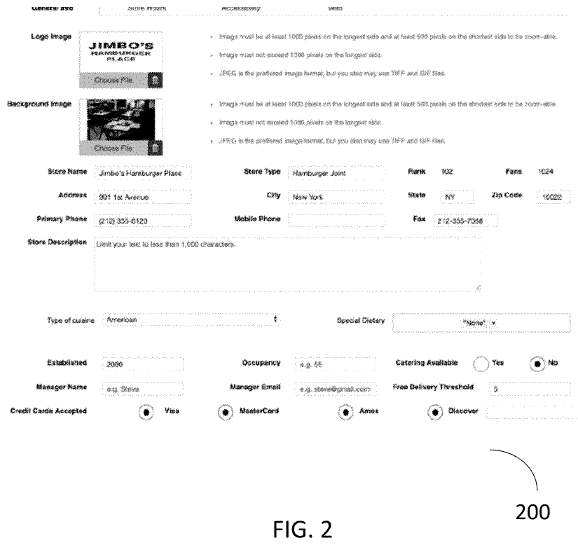

FIG. 2 illustrates a screenshot 200 for restaurant database. This database consists of general information of each restaurant includes: rank, type of cuisine, special dietaries and address among other important details about the restaurant. It's connected to Items database because it provides certain details to the items of the restaurant. Restaurant Database further contains the following information: Rank which is the result of performance of the restaurant multiplied by the total number of orders of the restaurant, at the same time multiplied by the average of likes on all the items on the restaurant menu Then we get a score that is compared with the scores of other restaurants. The rank determines the placement of a particular restaurant in a list of restaurants that sells similar types of cuisines.

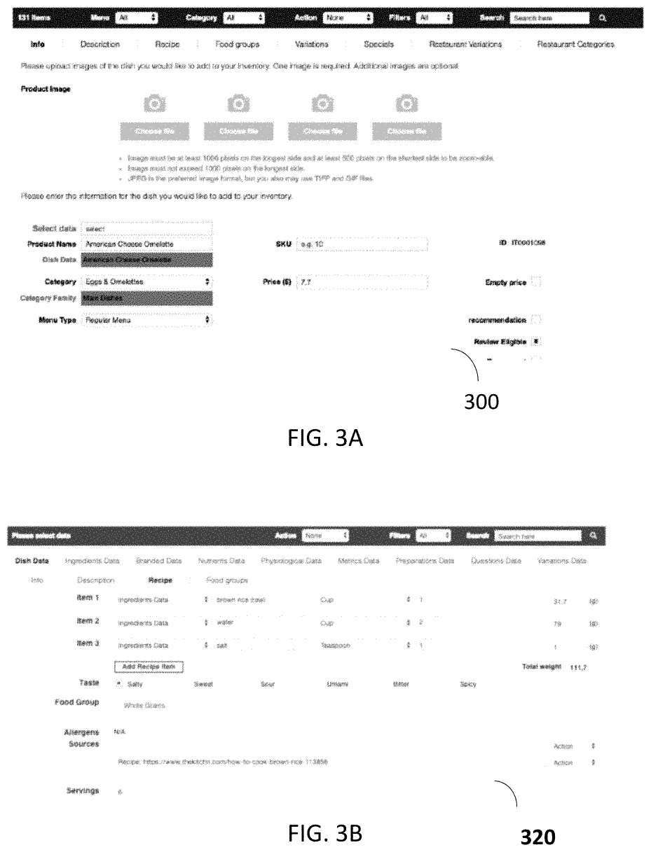

FIG. 3A illustrates screenshot 300 of item database. Items database is the central information transit. It's connected to all the existent databases. It generates its information getting details and values from ingredients, recipe and restaurants databases. And at the same time, it

provides all information to users database. FIG. 3B illustrates a screenshot 320 of recipe database. Recipe database is connected to ingredients and items databases. It consists of a list of general items and recipes with its corresponding ingredients and metrics. The information contained for each recipe template consist of composition, taste, food groups, allergens, source, servings, nutrition facts, density and metrics.

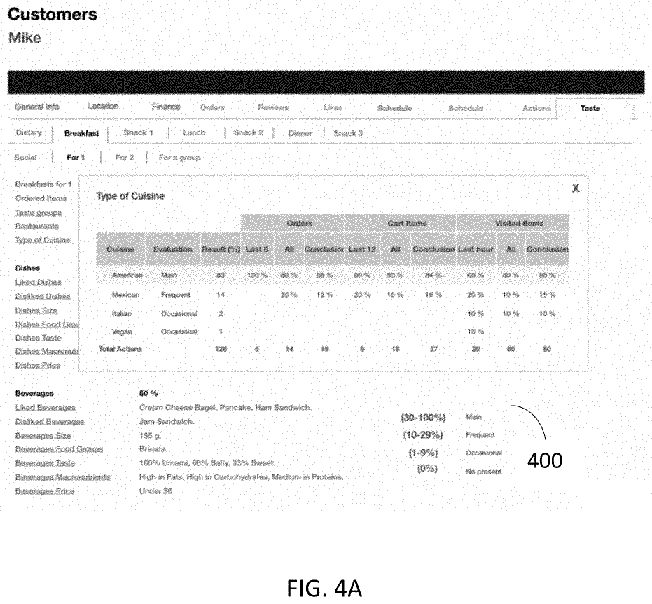

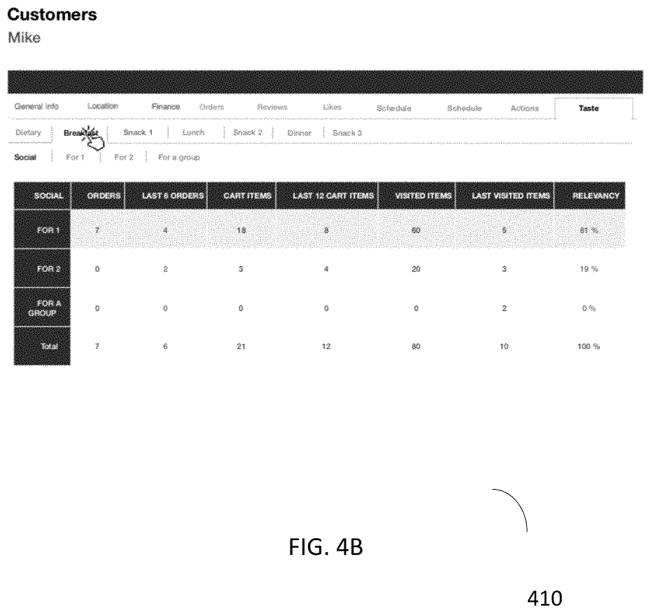

FIG. 4A illustrates screenshot 400 showing the preferences in type of cuisine will be evaluated in general for all groups of taste. The system will attribute a relevance percentage to each type of cuisine and it will help the system to classify the cuisine into main, frequent, occasional etc. The aim of the system of databases apart from storing information is to generate customer food preferences according to different social conditions and for different mealtimes. The novelty of the system consists of the relevance of the information that the system generates about the customer without the need of asking them any potential questions. Once the databases of ingredients, recipes and restaurants is entered and once the database items are adapted, the system works by itself to study the customer behaviour on the website and get several conclusion that can result important to recommend restaurant food items. Those conclusions are liked or disliked food items; customer order schedule i.e. different mealtimes of the day when the customer orders food; social groups i.e. for how many people the customer usually orders, preferences of each social group in terms of food items depending on the mealtime; Special diets ordered by the customers; types of cuisine ordered; preferences for each type of items.

FIG. 4B For each mealtime, the first thing that the system does is to calculate the distribution of social groups in order to show which is the most prevalent social group of a particular mealtime. Here the last actions of the customer will give us more information about the social groups. At the same time, ordered items would have a higher relevancy than the cart items and visited items of the customer during food ordering process.

Once the system has all the necessary information, the artificial intelligence algorithm compares information from databases to information provided by the user in the user database. The said algorithm compares information based on 16 variables: restaurant carrier, restaurant proximity, mealtime schedule, restaurant timings, types of cuisine, category family, previous orders, special dietary, food groups, macronutrients, allergens, price, serving size, food popularity, taste and restaurant popularity.

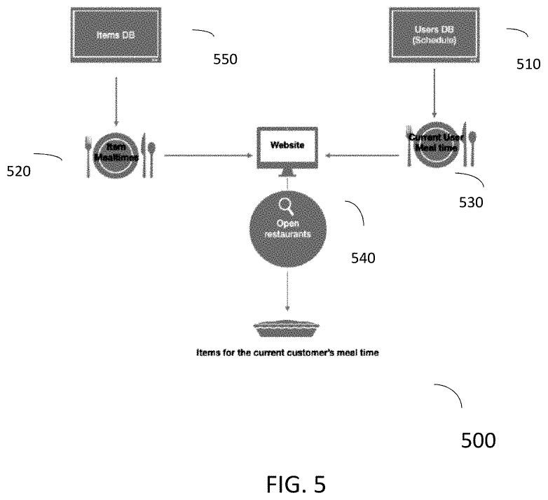

FIG. 5 illustrates screenshot 500 wherein the system extracts data to compare a mealtime. The system takes a look into the schedule of the customer from user database 510 and check the mealtimes of the food items through items database 550, the knowledge about the customer mealtime will help in generating recommendations that meet general food preferences of a specific mealtime 520. The system will search amongst all open restaurants 540 and find food items belonging to current specific mealtime 530.

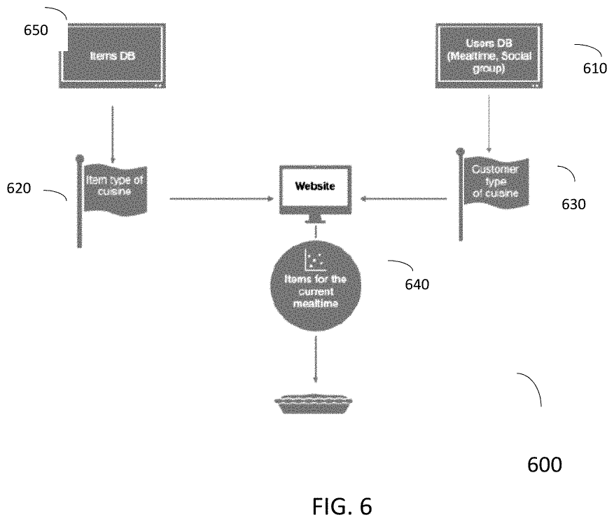

FIG. 6 illustrates screenshot 600 wherein the system extracts data to compare types of cuisine. Customers might have preferences for certain types of cuisine instead of others. User database 610 generates information about the main, frequent, occasional types of cuisine. To know the items cuisine, the system looks into items database 650. The system further evaluates restaurants according to the preferences of the customer for their type of cuisine 630. In order to know the customer cuisine, the system searches for the current customer mealtime and on the most prevalent social group.

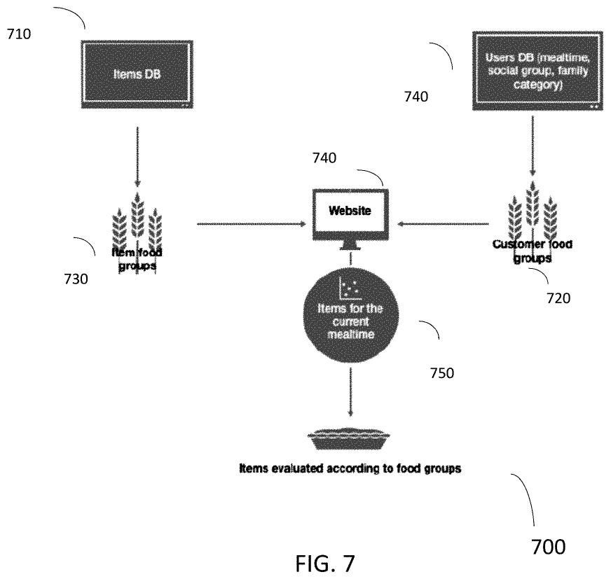

FIG. 7 illustrates screenshot 700 wherein the system extracts data to compare food groups. The system creates food groups according to the most hated or loved ingredients, popularity and sensorial characteristics. Each group contains ingredients sharing the same characteristics. If the system detects the customer does not like an ingredient from that food group, the system will not recommend the rest of the ingredients of that food group. On the contrary, if the system detects that the customer likes an ingredient from the specific food group then the system will allow customers to find new ingredients that they may like and didn't even know. This is possible because of an intuitive artificial intelligence based algorithm. In order to know the evaluation of the customer food groups 720; the system searches the user database 740 looking for current mealtime of the customer, the most relevant social group.

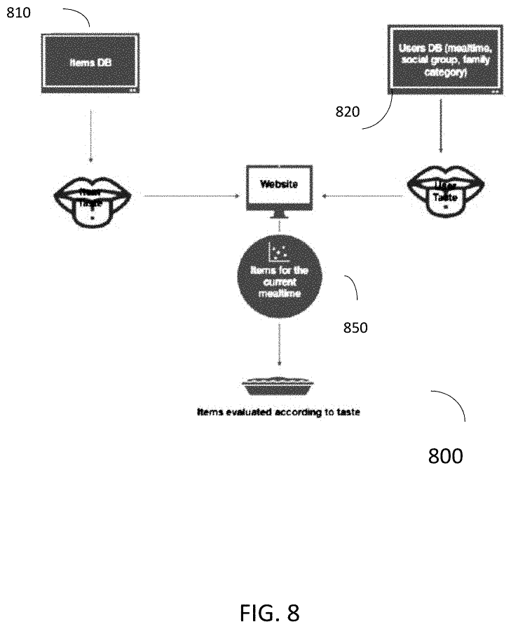

FIG. 8 illustrates screenshot 800 wherein the system extracts data to compare tastes. It is common that some people do not like bitter or spicy taste in few food family categories. These customers have different preferences depending on the mealtime. For e.g. it's common to eat spicy food for lunch or dinner but not breakfast. For these reasons in order to find out the right information on the user database 820, the system will need to look for the current mealtime 850, the social group and the family category of the item that the system wants to compare. A food item extracted from the items database 810 may have more than one taste, so the system will compare all the tastes contained in the items database to regular taste of the customer. The system then calculates the average of all the values and the results is multiplied by the rest of variables.

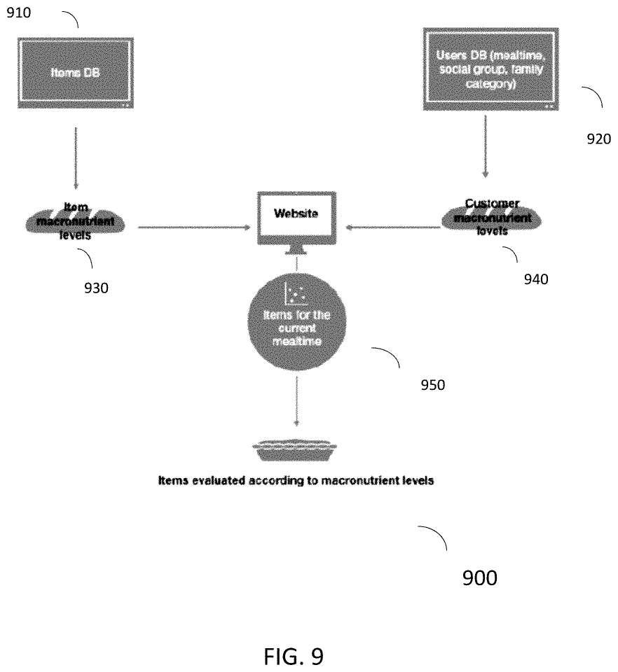

FIG. 9 illustrates screenshot 900 wherein the system extracts data from food items database 910 and user database 920 to compare macronutrients level 930. The proportion of macronutrients of one customer dish 940 can make people decide to order one dish instead of other. In order to set different levels of macronutrients, the system uses Macronutrients daily values according to dietary reference intake of USDA. System calculates the average score of the macronutrients multiplied by rest of the variables.

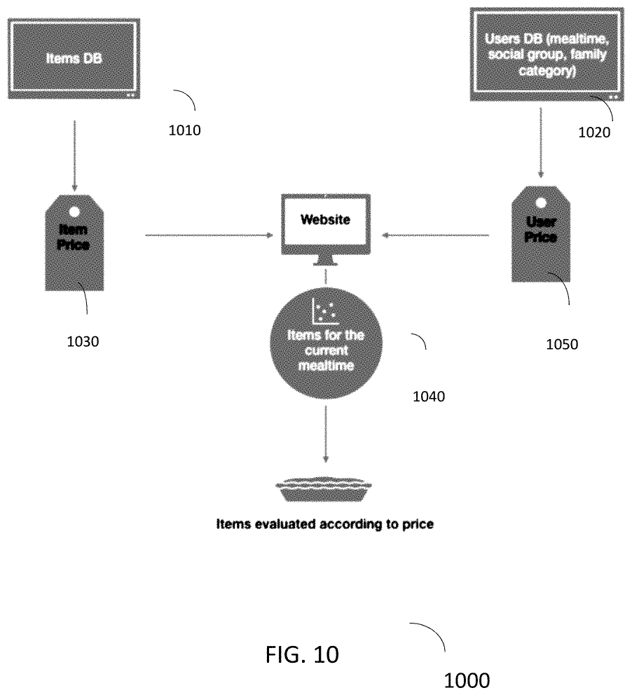

FIG. 10 illustrates screenshot 1000 wherein the system extracts data to compare prices of the food items. The relation between price and serving size enables people to finally order an item from items database 1010. In order to recommend items to comply with orderer's budget, the system will compare prices of the items 1030 with the regular range of the price 1050 of the customer generated by the system on the user database 1020.

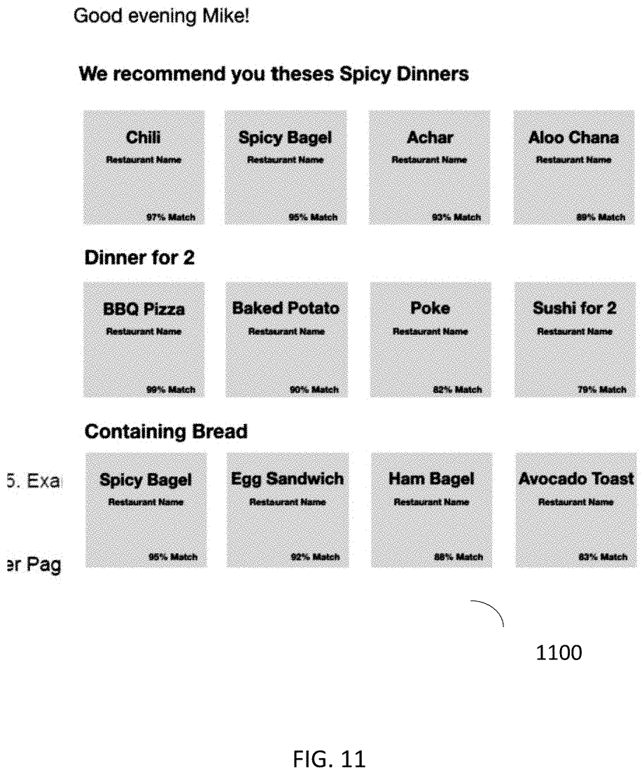

FIG. 11 illustrates screenshot 1100 wherein the system reflects recommendations of the food items.

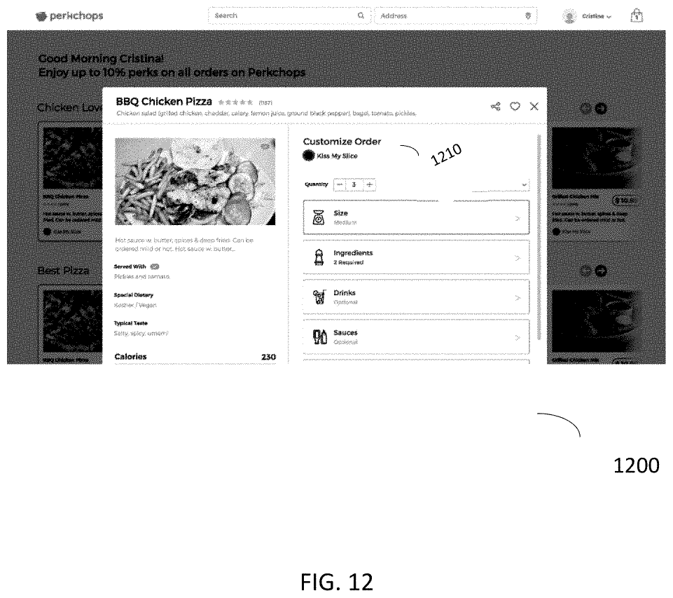

FIG. 12 illustrates screenshot 1200 of the graphical user interface wherein the customer or user may customize the order at 1210 based on ingredients, size serving, drinks, sauces, etc. The user may select the desired option to customize the order.

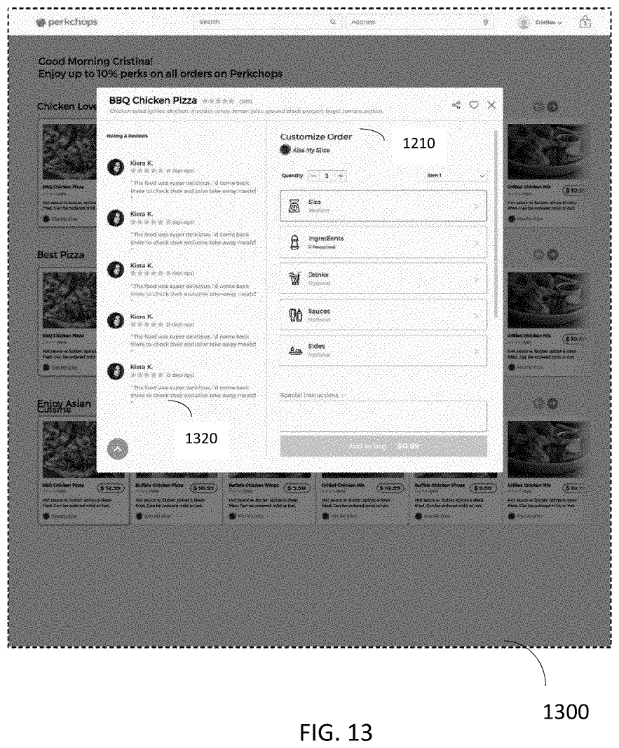

FIG. 13 illustrates screenshot 1300 of the graphical user interface of the present system. User or customer may customize the menu at 1210 and the reviews and ratings generated by the system appears at 1320.

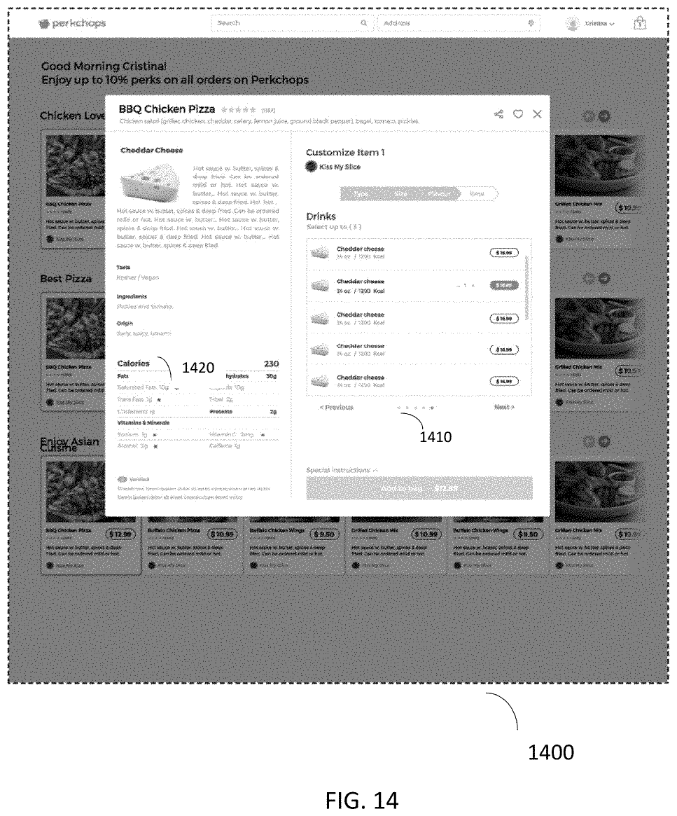

FIG. 14 illustrates yet another screenshot 1400, wherein the user may customize the food items at 1410 and give detailed account of nutritional value alongside at 1420.

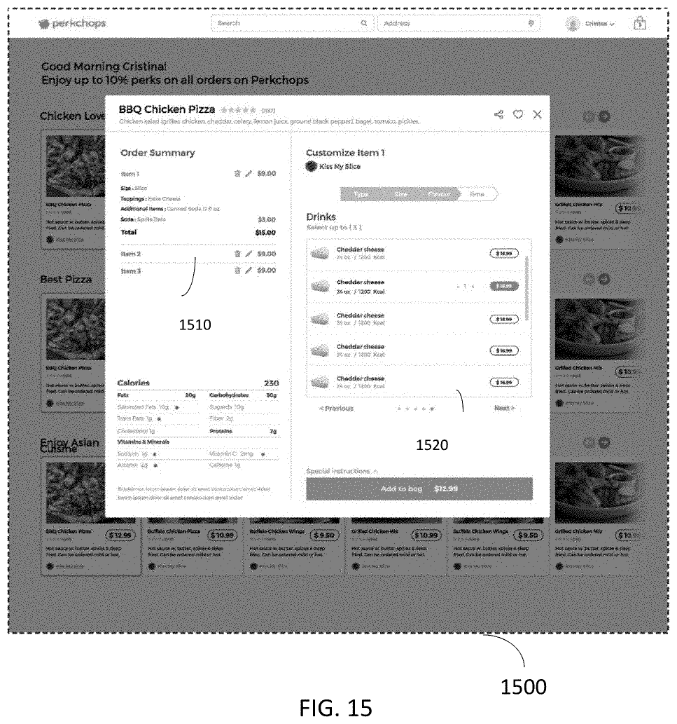

FIG. 15 illustrates screenshot 1500, wherein the user may customize the food items at 1520 and pay for the ordered items after reviewing the summary of customized items at 1510.

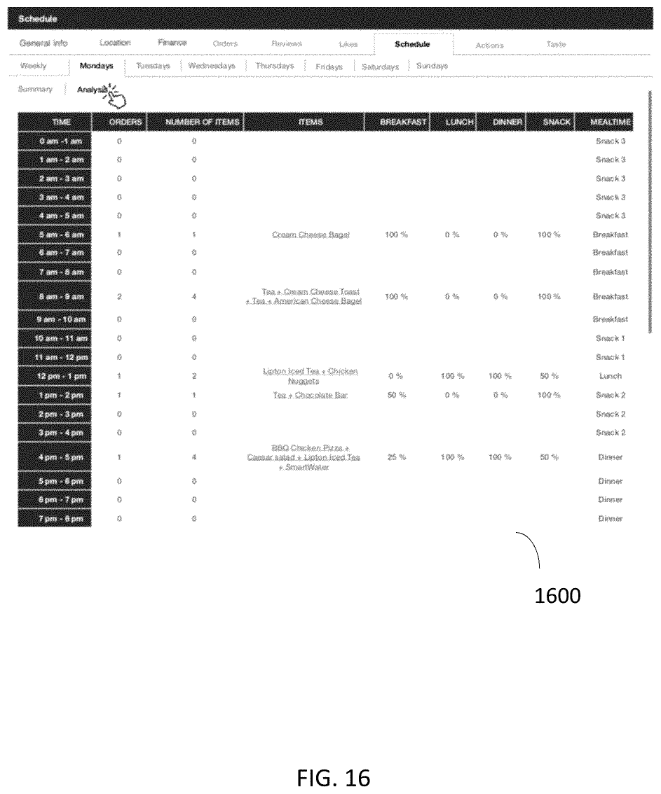

FIG. 16 illustrates screenshot 1600, showing the evaluation of the schedule of mealtimes of each user. Items are classified according to the day of the week in which they were ordered and the time of ordering. The information about the mealtime of each item is used to evaluate the most relevant mealtime in ranges of one hour. The mealtime with the highest relevancy for a range of time of one hour will be the one concluded by the system. The information of the schedule is used by the present system to recommend food items that contain the user preferences for the current mealtime.

While a number of preferred embodiments have been described, it will be appreciated by persons skilled in the art that numerous variations and/or modifications may be made to the invention without departing from the spirit or scope of the invention as broadly described. The specification uses words “user” and “customer” interchangeably. The present embodiments are, therefore, to be considered in all respects as illustrative and not restrictive.

I/We claim:

1. A system of food recommendation wherein
a. the system consists of five primary databases including restaurant database, items database, recipe database, ingredients database and user database;
b. the said databases work interdependently extracting information from each other;
c. the system works on an artificial intelligence based intuitive algorithm imitating real-life logic used during food ordering and decision making process to generate recommendations of the food items while ordering food online.

2. A system of food recommendation according to claim 1, wherein the artificial intelligence based algorithm works on sixteen variables applied to items and user databases to provide results for each item in relation to the user.

3. A system of food recommendation according to claim 2, wherein the sixteen variables include restaurant carrier, restaurant proximity, mealtime schedule, restaurant timings, types of cuisine, category family, previous orders, special dietary, food groups, macronutrients, allergens, price, serving size, food popularity, and restaurant popularity and taste.

4. A system of food recommendation wherein the said system extracts data to compare:
a. mealtimes of the users ordering food online;
b. type of cuisine ordered by the user;
c. food groups based on popularity of the dishes and sensorial characteristics of the dishes;
d. taste of the ordered food items;
e. macronutrient level of the ordered food items;
f. prices of the ordered food items.

5. A system of food recommendation according to claim 1, wherein the system reviews the schedule of the customer from user database and check the mealtimes of the food items through items database, this knowledge about the customer mealtime will help in generating recommendations that meet general food preferences of a specific mealtime.

6. A system of food recommendation according to claim 5, wherein the system searches amongst all open restaurants and find food items belonging to specific mealtime.

7. A system of recommending food according to claim 6, wherein the weight of the food item is compared with the regular size of the food items generated by the user database.

8. A system of recommending food according to claim 7, wherein in order to find the regular price of the food items that the customer consumes, the said system searches for the mealtime, most relevant social group and the family category.

9. A system of recommending food wherein the system evaluates the regular time schedule at which the customer eats meals.

10. A system according to claim 9, wherein the mealtime with the highest percentage of ordered items will be prevalent in that range of time.

11. A method of food recommendation wherein
a. There are five primary databases including restaurant database, items database, recipe database, ingredients database and user database;
b. the said databases work interdependently extracting information from each other;
c. an artificial intelligence based intuitive algorithm imitates real-life logic used during food ordering and decision making process to generate recommendations of the food items while ordering food online.

12. A method of food recommendation wherein the said system extracts data to compare:
a. mealtimes of the users ordering food online;
b. type of cuisine ordered by the user;
c. food groups based on popularity of the dishes and sensorial characteristics of the dishes;
d. taste of the ordered food items;
e. macronutrient level of the ordered food items;
f. prices of the ordered food items.

13. A method of food recommendation according to claim 11, wherein the schedule of the customer is reviewed from user database and check the mealtimes of the food items through items database, this knowledge about the customer mealtime will help in generating recommendations that meet general food preferences of a specific mealtime.

14. A method of food recommendation according to claim 13, wherein the search is performed amongst all open restaurants and find food items belonging to specific mealtime.

15. A method of recommending food according to claim 14, wherein the weight of the food item is compared with the regular size of the food items generated by the user database.

16. A method of recommending food according to claim 14, wherein search is performed for the meal time, most relevant social group and by family category. In order to find the regular price of the items that the customer consumes, the method searches for mealtime, most relevant social group and family category.
